(19) United States
(12) Patent Application Publication
(10) Pub. No.: US 2022/0345911 A1
(43) Pub. Date: Oct. 27, 2022

(54) IMPROVED SPECTRUM UTILIZATION IN A WIRELESS COMMUNICATION NETWORK

(71) Applicant: Telefonaktiebolaget LM Ericsson (publ), Stockholm (SE)

(72) Inventors: Behrooz MAKKI, Pixbo (SE); Mikael COLDREY, Borås (SE)

(73) Assignee: Telefonaktiebolaget LM Ericsson (publ), Stockholm (SE)

(21) Appl. No.: 17/639,194

(22) PCT Filed: Sep. 2, 2019
(86) PCT No.: PCT/SE2019/050820

§ 371 Date: Feb. 28, 2022

(51) Int. Cl. H04W 24/02

(52) U.S. Cl. CPC H04W 24/02; H04W 92/20

(57) ABSTRACT

The present disclosure relates to first type node (AP₀) in a wireless communication system (1), wherein the first type node (AP₀) is adapted to: —communicate with at least one other first type node (AP₁, AP₂) in the wireless communication system (1) over a corresponding backhaul channel (H₁, H₄), —acquire a prediction for information (X₂₃) to be requested via at least one of said other first type nodes (AP₂, AP₃), and to —transmit the predicted information (X₂₃) to one of said other first type nodes (AP₂) for buffer storage and/or relaying.

### TECHNICAL FIELD

The present disclosure relates to relaying in wireless communication networks, in particular in integrated access and backhaul (IAB) networks.

### BACKGROUND

The fifth generation of wireless networks (5G) must provide high-rate data streams for everyone everywhere at any time. To meet such demands, it is required to use large bandwidths. Here, it is mainly concentrated on millimeter wave-based, potentially, massive multiple-input and multiple-output (MMIMO), links as a key enabler to obtain sufficiently large bandwidths/data rates. Importantly, the presence of very wide bandwidths makes it possible to include the wireless backhaul transport in the same spectrum as the wireless access. In such a setup, there is thus a sharing of radio resources between access and backhaul links which implies that access and backhaul links compete over the same radio resources pool.

For this reason, 3GPP has considered such integrated access and backhaul (IAB) network configurations where an access point (AP), that for example can be fiber-connected, provides other APs as well as the customer-premises equipments (CPEs) inside its cell area with wireless backhaul and access connections, respectively. The access-integrated backhaul link can either be a single-hop or multi-hop link in an IAB network. In a multi-hop deployment, the IAB network from one AP is relayed along a certain route from AP to AP until it reaches its destination. IAB networks can thus have either star-like configuration with multiple APs wirelessly backhauled through direct single-hop connections to the fiber-connected AP, or a cascade configuration with APs wirelessly connected to the fiber-connected AP in a multi-hop fashion.

It is desired to densify the network with a large number of access points (AP:s), each one serving a number of CPE:s inside its corresponding relatively small cell area. Compared to the cases with few macro base stations covering a wide area, less path loss/shadowing, and higher Line Of Sight (LOS) connection probability are expected in dense small-cell networks. As a result, better channel quality is experienced in these short-range links, compared to the cases with few macro base stations.

Among the advantageous of IAB networks are the followings:

Cost Reduction:

A fiber optic link is relatively expensive in metropolitan areas, with a majority of the total figure tied to trenching and installation. For this reason, as well as the traffic jams and infrastructure displacements, some cities have considered a moratorium on fiber trenching specially in historical areas. In such scenarios, millimeter wave-based wireless backhaul is the best alternative providing almost the same rate as fiber optic with significantly less price and no digging.

Link Quality Enhancement:

Compared to the direct macro base station (BS)-CPE link, less path loss/shadowing, and higher line-of-sight (LOS) connection probability are expected for the wirelessly backhauled AP-CPE connections within small cells. As a result, better channel quality is experienced in such small cells, compared to the cases with direct macro BS-CPE connection.

Long-Term Network Planning:

IAB systems are of most interest in small cell backhaul and fixed wireless access (FWA) networks with stationary APs/CPEs. This makes it possible to predict the channel quality and perform accurate network planning for multiple packet transmissions.

In a multi-hop IAB network, the backhaul links are the bottleneck of the transmission setup. As an example, the IAB node directly connected to the fiber-connected IAB donor node is the most loaded node of the network which needs to transmit/receive messages of its associated CPEs as well as all other IAB nodes. This leads to high end-to-end and scheduling delay for the last hops of the network. Importantly, the spectrum is not efficiently used by different IAB nodes of the multi-hop setup because they some IAB nodes have to remain off for some periods and wait for one or more other highly-loaded IAB nodes to finish their data transmission. Therefore, to support a large number of hops and/or CPEs-per-hop, it is desired to have data transmission schemes enabling not only the load of the highly-loaded IAB nodes to be reduced, but also avoiding the spectrum underutilization of the other nodes.

### SUMMARY

It is an object of the present disclosure to provide a node in a wireless communication system which communicate with at least one other node, where it is desired that the load of highly-loaded nodes is reduced, and that spectrum underutilization of the other nodes is avoided.

This object is obtained by means of a first type node in a wireless communication system where the first type node is adapted to communicate with at least one other first type node in the wireless communication system over a corresponding backhaul channel. The first type node is further adapted to acquire a prediction for information to be requested via at least one of said other first type nodes, and to transmit the predicted information to one of said other first type nodes for buffer storage and/or relaying.

This means that information that is likely to be requested can be forwarded and buffered at suitable times, decreasing the load of the wireless communication system, which may give the chance to increase the number of hops.

According to some aspects, the first type node is adapted to communicate with at least two other first type nodes, and the first type node is adapted to transmit the predicted information to a second closest, or more remote, first type node, via a direct backhaul channel, for buffer storage and/or relaying.

This enables bypassing highly loaded first type nodes, reduced their load and avoiding spectrum underutilization. This leads to better balance of the load in different first type nodes, higher end-to-end throughput and better energy efficiency, and may give the chance to increase the number of hops.

According to some aspects, at least one of the other first type nodes is adapted to communicate with a corresponding group of second type nodes via a corresponding access channel, each group of second type nodes comprising at least one second type node. Information to be requested via at least one of said other first type nodes corresponds to information to be requested by at least one of said second type nodes.

This enables scheduling and end-to-end data transmission delay for the second type nodes to be reduced, and may give the chance to increase the number of hops and/or CPEs-per-hop.

According to some aspects, the communication between the first type nodes is a backhaul communication via at least one corresponding backhaul channel, where the backhaul communication and the access communication both are performed by means of common equipment at each one of the first type nodes.

This means that the present disclosure is applicable to a common IAB network.

According to some aspects, the first type node is adapted to perform the prediction. Alternatively, according to some further aspects, the first type node is adapted to acquire the prediction from at least one of said other first type nodes.

This means that the prediction ability can be implemented where suitable.

According to some aspects, the prediction is based on previously requested information, and preferably, the previously requested information mostly comprises video information.

In this way the reliability of the prediction becomes relatively high.

According to some aspects, the transmitted predicted information is relayed from one other first type node to another first type node.

In this way, all sorts of first type nodes can benefit from the present disclosure.

According to some aspects, the first type node is adapted to determine if requested information already has been transmitted to one of said other first type nodes for buffer storage and/or relaying, the requested information then having been comprised in the predicted information.

In this way, requested information that has been buffered does not have to be transmitted again.

This object is also obtained by means of a first type node in a wireless communication system, wherein the first type node is adapted to communicate with at least one other first type node in the wireless communication system over a corresponding backhaul channel. The first type node is further adapted to receive and buffer and/or relay predicted information from at least one of said other first type nodes, where the predicted information has been predicted to be requested via at least one second type node that is served by a first type node.

This means that information that is likely to be requested can be forwarded and buffered at suitable times, decreasing the load of the wireless communication system, which may give the chance to increase the number of hops.

According to some aspects, the first type node is adapted to communicate with at least two other first type nodes, and to receive predicted information from a second closest, or more remote, first type node, via a direct backhaul channel, for buffer storage and/or relaying.

This enables bypassing highly loaded first type nodes, reduced their load and avoiding spectrum underutilization. This leads to better balance of the load in different first type nodes, higher end-to-end throughput and better energy efficiency, and may give the chance to increase the number of hops.

According to some aspects, the first type node is adapted to relay the received predicted information to be stored and buffered at another first type node, where said second type node is served by said another first type node.

In this way, all sorts of first type nodes can benefit from the present disclosure.

According to some aspects, the first type node is adapted to serve a corresponding group of second type nodes via a corresponding access channel, each group of second type nodes comprising at least one second type node. The first type node is further adapted to receive request for information from at least one of the second type nodes, and to determine if the requested information already has been buffered. If that is the case, the first type node is adapted to directly forward the requested information to said second type nodes from the present buffer storage, otherwise request the information from one other first type node.

In this way, requested information that has been buffered does not have to be transmitted again, while not buffered information is requested in uplink.

According to some aspects, the first type node is adapted to perform the prediction, and to request the predicted information from another first type node.

This means that the prediction ability can be implemented where suitable.

This object is also obtained by means of methods and a communication system that are associated with the above advantages.

### BRIEF DESCRIPTION OF THE DRAWINGS

The present disclosure will now be described more in detail with reference to the appended drawings, where:

FIG. 1 schematically shows a view of a wireless communication system;

FIG. 2 schematically shows a timing diagram for the wireless communication system;

FIG. 3 shows a flowchart of methods according to embodiments;

FIG. 4 shows a flowchart of methods according to embodiments;

FIG. 5A schematically shows a first type node; and

FIG. 5B schematically shows a first type node.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

Network densification takes advantage of wireless backhaul; due to a relatively high installation cost of fiber links, as well as traffic jams and infrastructure displacements, the relatively small application points (APs) need to be supported by high-rate LOS wireless backhaul links which motivates so-called integrated access and backhaul (IAB) networks.

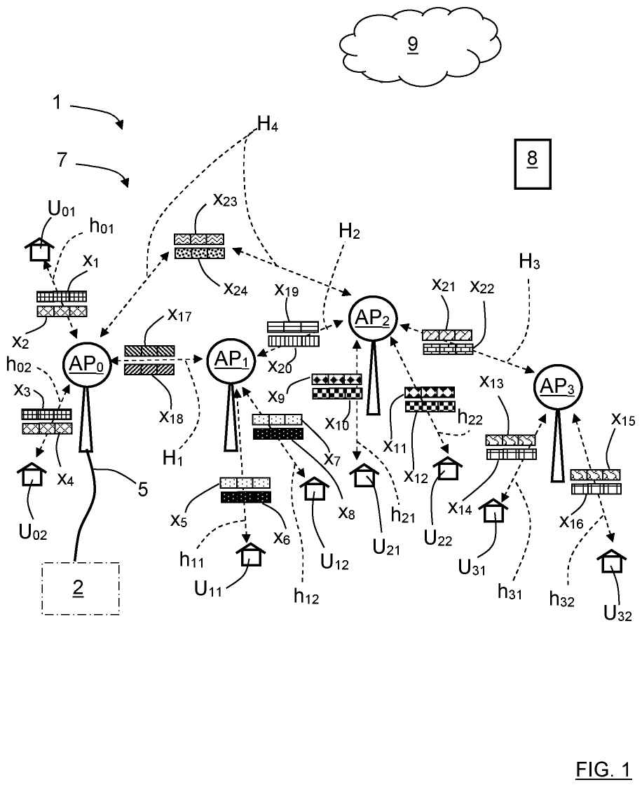

With reference to FIG. 1, there is a wireless communication system 1 comprising an IAB network 7 with four hops. There are first type nodes AP₀, AP₁, AP₂, AP₃ in the wireless communication system 1, here in the form of a first access point AP₀, a second access point AP₁ a third access point AP₂ and a fourth access point AP₃. The access points AP₀, AP₁, AP₂, AP₃ are arranged for communication with each other in the wireless communication system 1 over a corresponding backhaul channel H₁, H₂, H₃ having a certain channel quality, generally by means of one of at least one type of signal relaying that according to some aspects employs decoding and encoding. According to some aspects, the signal relaying is constituted by decoding-encoding forward, DF, relaying of a signal.

Each access point AP₀, AP₁, AP₂ AP₃ is adapted for access communication with a corresponding group of second type nodes U₀₁, U₀₂; U₁₁, U₁₂; U₂₁, U₂₂; U₃₁, U₃₂ via a corresponding access channel h₀₁, h₀₂; h₁₁, h₁₂; h₂₁, h₂₂; h₃₁, h₃₂, providing wireless access. The second type nodes U₀₁, U₀₂; U₁₁, U₁₂; U₂₁, U₂₂; U₃₁, U₃₂ are here in the form of customer-premises equipments (CPE:s), and generally each group of CPE:s U₀₁, U₀₂; U₁₁, U₁₂; U₂₁, U₂₂; U₃₁, U₃₂ comprises at least one CPE. The number of CPE:s for each access point AP₀, AP₁, AP₂ AP₃ in FIG. 1 is only an example; there can be any number of CPE:s for each access point AP₀, AP₁, AP₂ AP₃. One or more access points can according to some aspects lack CPE:s to serve, only serving as relaying nodes. Generally, a network with N access points and m CPE:s per access point. Also, the CPE:s served by AP₁ are generally denoted by Uᵢⱼ, j=1, . . . , m.

The backhaul communication and the access communication are both performed by means of common equipment at the access points AP₀, AP₁, AP₂ AP₃. The second access point AP₁, the third access point AP₂ and the fourth access point AP₃ are wirelessly backhauled by the first access point AP₀ connecting to a core network 2 using a fiber connection 5. An access point AP₀ connected to a core network can be referred to as an IAB donor node.

In IAB networks, uplink (UL) and downlink (DL) transmission do not follow the common definition, as both endpoints of the backhaul links are access points. However, for simplicity, we refer to data transmission towards (resp. from) the first access point AP₀ as UL (resp. DL) transmission. The present disclosure is applicable for DL transmission from the first access point AP₀ to the other nodes.

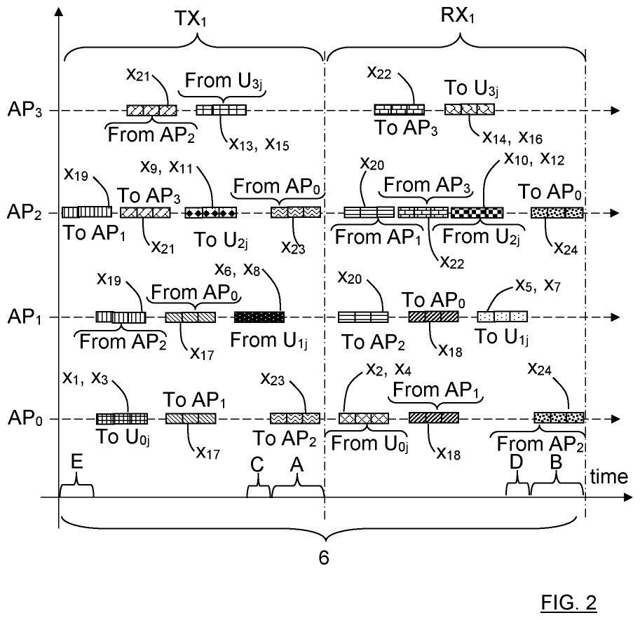

Different scheduling protocols can be considered, and in the following example a time slot 6 is divided into transmit (Tx) and receive (Rx) sub-slots TX₁, RX₁ for the first access point AP₀, and in each one there is both backhaul and access connections. Considering FIG. 2, this means that the discussions relate to both UL transmission from the CPE:s U₀₁, U₀₂; U₁₁, U₁₂; U₂₁, U₂₂; U₃₁, U₃₂ to the first access point AP₀. and DL transmission from the first access point AP₀ to the CPE:s U₀₁, U₀₂; U₁₁, U₁₂; U₂₁, U₂₂; U₃₁, U₃₂. Also, the setup is discussed for time-division multiple access (TDMA) setup. However, the same scheme can also be adapted for other resource allocation approaches such as for example frequency-division multiple access (FDMA) and code-division multiple access (CDMA).

As the number of hops/CPEs per hop increases, the AP:s need to transfer an aggregated data of multiple CPE:s accumulated from the previous hops. As a result, the AP-AP backhaul links are heavily loaded, which may lead to high decoding complexity/delay and buffering cost for the AP:s as well as large end-to-end transmission delay/low end-to-end throughput for the CPE:s. This becomes more and more pronounced the closer an AP is to an access point AP₀ that is connected to a core network 2.

More in detail, in a genera case, for each time slot, the first access point AP₀ needs to send 2 Nm signals for both its m CPEs, m DL and m UL signals, in access and the DL/UL backhaul signals for (N−1)m CPEs of the other access points AP₁, AP₂, AP₃. Then, access point i>0 needs to transfer 2(2 Nm−im) signals in total, both access and backhaul, DL and UL. As a result, the second access point, AP₁ is the busiest node being active during the whole time slot, while the other access points AP₂, AP₃ may be off in some periods and wait for the previous hops to finish their data transmission.

This is because:
Part of the spectrum is underutilized because different access points need to wait until the data transmission of the more loaded access points are finished, and
The high load of the second access point AP₁ and other highly loaded nodes leads to large scheduling delay for all CPE:s.

On the other hand, IAB networks are mostly designed for, e.g., fixed wireless access (FWA) networks, with stationary CPE:s for which the required signals of the CPE:s can be predicted with high accuracy.

According to the present disclosure, with reference to FIG. 1 and FIG. 2, in order to overcome this dilemma, the first access point AP₀ is adapted to acquire a prediction for information x₂₃ to be requested via the third access point AP₂, and to transmit the predicted information x₂₃ directly to the third access point AP₂ for buffer storage via a direct backhaul channel H₄. The third access point AP₂ is adapted to communicate with a corresponding group of CPE:s U₂₁, U₂₂ via corresponding access channels h₂₁, h₂₂, where the predicted information x₂₃ to be requested via the third access point AP₂ corresponds to information to be requested by the group of CPE:s U₂₁, U₂₂.

This means that the first access point AP₀ is adapted to acquire a prediction for information x₂₃ to be requested by the CPE:s U₂₁, U₂₂, where this predicted information x₂₃ is to be relayed to the CPE:s U₂₁, U₂₂ via the third access point AP₂.

According to some aspects, apart from the first access point AP₀, there are at least two other access points AP₁, AP₂, and the first access point AP₀ is adapted to transmit the predicted information x₂₃ to an at least second closest first type node AP₂, via the direct backhaul channel H₄, for buffer storage and/or relaying.

In the following, the flow of information in FIG. 1 and FIG. 2 will be described more in detail, and the present disclosure will be further explained. In the transmit sub-slot TX₁, the first access point AP₀ is transmitting information x₁, x₃ to its served CPE:s U₀₁, U₀₂, and information x₁₇ to the second access point AP₁. The second access point AP₁ receives information x₁₉ from the third access point AP₂, the information x₁₇ from the first access point AP₀ and information x₆, x₈ from its served CPE:s U₁₁, U₁₂. The third access point AP₂ transmits the information x₁₉ to the second access point AP₁, information x₂₁ to the fourth access point AP₃ and information x₉, x₁₁ to its served CPE:s U₂₁, U₂₂. The fourth access point AP₃ receives the information x₂₁ from the third access point AP₂, and information x₁₃, x₁₅ from its served CPE:s U₃₁, U₃₂.

Furthermore, in accordance with the present disclosure, the first access point AP₀ has acquired a prediction for information x₂₃ to be requested by the CPE:s U₂₁, U₂₂ that are served by the third access point AP₂. The first access point AP₀ can therefore take advantage of a first time period A in the transmit sub-slot TX₁, when the first access point AP₀ and the third access point AP₂ are idle, to transmit this predicted information x₂₃ to the third access point AP₂ where the predicted information x₂₃ is stored in a buffer. This transmission takes place via the direct backhaul channel H₄ between the first access point AP₀ and the third access point AP₂.

Since the predicted information x₂₃ has been transmitted to the third access point AP₂ based on a prediction, it is not a fact that this information will be requested by the CPE:s U₂₁, U₂₂ that are served by the third access point AP₂. If this does not happen within a certain time period, and/or if other substitute information is transmitted, the predicted information x₂₃ is deleted from the buffer. On the other hand, should the predicted information x₂₃ be requested by the CPE:s U₂₁, U₂₂ that are served by the third access point AP₂, the buffered predicted information x₂₃ can be immediately relayed to the CPE:s U₂₁, U₂₂.

In the receive sub-slot RX₁, the first access point AP₀ is receiving information x₂, x₄ from its served CPE:s U₀₁, U₀₂, and information x₁₈ from the second access point AP₁. The second access point AP₁ transmits information x₂₀ to the third access point AP₂, the information x₁₈ to the first access point AP₀ and information x₅, x₇ to its served CPE:s U₁₁, U₁₂. The third access point AP₂ receives the information x₂₀ from the second access point AP₁, information x₂₂ from the fourth access point AP₃ and information x₁₀, x₁₂ from its served CPE:s U₂₁, U₂₂. The fourth access point AP₃ transmits the information x₂₂ to the third access point AP₂, and information x₁₄, x₁₆ to its served CPE:s U₃₁, U₃₂.

Furthermore, in accordance with the present disclosure, the third access point AP₂ can take advantage of a second time period B in the receive sub-slot RX₁, when the first access point AP₀ and the third access point AP₂ are idle, to transmit information x₂₄ to the first access point AP₀ via the direct backhaul channel H₄ between the first access point AP₀ and the third access point AP₂. This information x₂₄ can for example comprise information that requested data from the CPE:s U₂₁, U₂₂ that are served by the third access point AP₂ already has been received.

There are two different alternatives for an access point that is adapted for direct backhaul communication with an access point AP₀ that is connected to a core network 2 using a fiber connection 5, in this example the third access point AP₂. Either the third access point AP₂ is adapted for encryption and decryption of the received information x₂₃ or not. In the following, the third access point AP₂ is assumed to be adapted for encryption and decryption, and the case where the third access point AP₂ is not adapted for encryption will be discussed afterwards where some important the differences will be illuminated.

According to some aspects, the first access point AP₀ uses an artificial intelligence-based, algorithm and the previous/current signal requests of the CPE:s to predict the next signals that may be requested by CPE:s U₂₁, U₂₂; U₃₁, U₃₂ that are served by an access point that is not closest to the first access point AP₀, here the third access point AP₂ and the fourth access point AP₃, and directly provide information x₂₃ which, with high probability, will be requested. As an example, if a CPE U₂₁, U₂₂ that is served by the third access point AP₂ is watching episode k of a TV series such as “Game of Thrones”, with high probability the next file that it requests is episode k+1 of “Game of Thrones”. Then the first access point AP₀ uses a normally idle time period such as the first time period A in FIG. 2 to directly connect to the third access point AP₂ and fill in its buffer with signal containing information x₂₃ that may be requested by the CPE:s U₂₁, U₂₂ that are served by the third access point AP₂ in a near future. Compared to data transmission in the link between the first access point AP₀ and the second access point AP₁ via the first channel H₁, the first access point AP₀ can according to some aspects use lower data rates/power and different beamforming when connecting to the third access point AP₂ directly via the direct channel H₄. According to some aspects, the timings are adapted depending on if the second access point AP₁ or the third access point AP₂ is receiving information from the first access point AP₀.

As mentioned above, according to some aspects, the third access point AP₂ is assumed to be adapted for encryption and decryption, and is thus adapted to decrypt and buffer the signals carrying information that are received in normally idle time periods. Then, receiving a signal request from one or more of the CPE:s Uᵢⱼ, j=1, . . . , m, i=2, 3, i.e. the CPE:s which are served by the third access point AP₂ and the fourth access point AP₃, the third access point AP₂ is adapted to run a search algorithm to find out if the requested information is in its buffered dataset or if it should receive it from the first access point AP₀ through backhauling.

If the requested information has not been previously buffered by the third access point AP₂, the normal backhaul path from the first access point AP₀ to the second access point AP₁ and finally to the third access point AP₂ via the corresponding channels H₁, H₂ is followed. If the requested information has been previously buffered by the third access point AP₂, the third access point AP₂ is adapted to inform the first access point AP₀ and the second access point AP₁ and to serve the considered CPE or CPE:s directly. Also, the resource allocation of all nodes and their timing are adapted based on the buffering status of the third access point AP₂ correspondingly.

This means that the third access point AP₂ encrypts and forwards the signal to the considered CPE, possibly via the fourth access point AP₃ if the request is made from any one of the CPE:s U₃₁, U₃₂ that are served by fourth access point AP₃ without any need for backhauling from the first access point AP₀. For instance the third access point AP₂ may use a third time period C and/or a fourth time period D in FIG. 2 to forward the buffered signal to fourth access point AP₃. Also, the third access point AP₂ is adapted to send signals to the first access point AP₀ and the second access point AP₁ to inform them if the requested information has been already received or they should provide the requested information.

Depending on if the requested information has been previously buffered by the third access point AP₂ or not, the first access point AP₀ and the second access point AP₁ are adapted to update their scheduling methods correspondingly. Moreover, the first access point AP₀ adapts its transmission parameters, e.g., data rate, power and beamforming, depending on the quality of the channel to the receiving application point in different time slots.

In this way, the load of the second access point AP₁ is reduced, and consequently the scheduling delay is reduced as well because part of the data is transferred through backhauling in the idle time periods A. Moreover, the spectrum utilization is improved by using the idle time periods A, which leads to lower end-to-end transmission delay and higher throughput for the CPE:s U₂₁, U₂₂; U₃₁, U₃₂ that are served by the third access point AP₂ and the fourth access point AP₃.

As discussed previously, encryption/decryption ability is not necessary for the third access point AP₂. Above, examples have been presented where the third access point AP₂ has been assumed to be able to encrypt/decrypt information received from the first access point AP₀ as well as the information requests of the CPE:s. According to some aspects, the third access point AP₂ is adapted to buffer information received in idle time periods A with no decryption. Also, without decryption functionality, the third access point AP₂ is adapted to forward the information requests of the served CPE:s U₂₁, U₂₂, U₃₁, U₃₂ to the first access point AP₀. Then the first access point AP₀ decrypts the information request of the CPE:s U₂₁, U₂₂; U₃₁, U₃₂ and runs search algorithm to find out if it has already sent the requested information to the third access point AP₂. If the information already has been sent the third access point AP₂, the first access point AP₀ is adapted to inform the third access point AP₂ about the codewords that should be forwarded to the requesting CPE:s U₂₁, U₂₂, U₃₁, U₃₂. This means that here, the search algorithm is run at the first access point AP₀ instead of at the third access point AP₂, and there is no need for message/information encryption/decryption at the third access point AP₂.

Furthermore, according to some aspects, the third access point AP₂, or any suitable AP or AP:s can be adapted to predict the next signals that may be requested by CPE:s U₂₁, U₂₂, U₃₁, U₃₂ that are served by an access point that is not closest to the first access point AP₀. This functionality can be implemented instead of, or as a complement to, the first access point AP₀ being adapted to perform such a prediction. In all cases, in order to be able to transmit the predicted information to an AP for buffer storage and/or relaying, the first access point AP₀ is adapted to acquire the prediction, irrespective of the first access point AP₀ generates the prediction, or if it is generated elsewhere. It is even conceivable that the prediction is generated at a remote node 8 or server 9 that can be realized in the cloud.

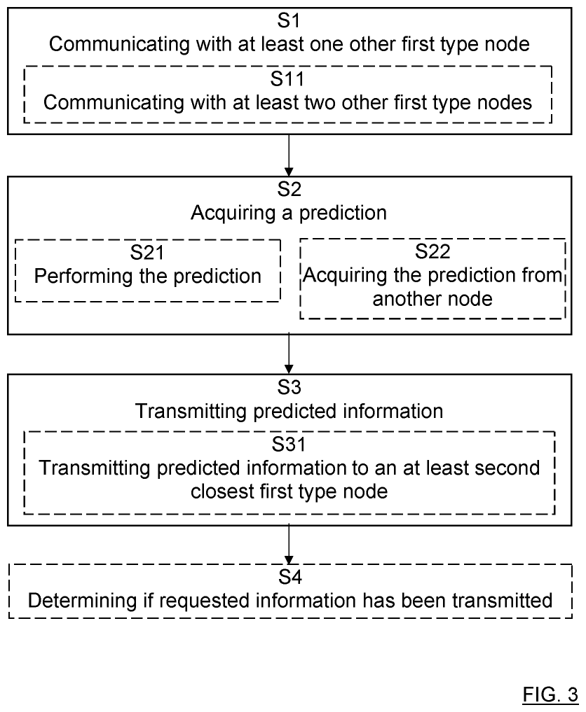

With reference to FIG. 3, the present disclosure also relates to a method in a first type node first type node AP₀ in a wireless communication system 1, wherein the method comprises communicating S1 with at least one other first type node AP₁, AP₂ in the wireless communication system 1 over a corresponding backhaul channel H₁, H₄, acquiring S2 a prediction for information x₂₃ to be requested via at least one of said other first type nodes AP₂, AP₃, and transmitting S3 the predicted information x₂₃ to one of said other first type nodes AP₂ for buffer storage and/or relaying.

According to some aspects, this applies to a case where aspects the present disclosure can be more or less implemented at an IAB donor node such as the first access point AP₀.

According to some aspects, the method comprises communicating S11 with at least two other first type nodes AP₁, AP₂, and transmitting S31 the predicted information x₂₃ to a second closest, or more remote, first type node AP₂, via a direct backhaul channel H₄, for buffer storage and/or relaying.

According to some aspects, at least one of the other first type nodes AP₁, AP₂, AP₃ is used for communicating with a corresponding group of second type nodes U₁₁, U₁₂, U₂₁, U₂₂, U₃₁, U₃₂ via a corresponding access channel h₁₁, h₁₂, h₂₁, h₂₂, h₃₁, h₃₂, each group of second type nodes U₁₁, U₁₂, U₂₁, U₂₂, U₃₁, U₃₂ comprising at least one second type node U₁₁, U₁₂, U₂₁, U₂₂, U₃₁, U₃₂, where information x₂₃ to be requested via at least one of said other first type nodes AP₂, AP₃ corresponds to information to be requested by at least one of said second type nodes Uzi, U₂₂, U₃₁, U₃₂.

According to some aspects, the communication between the first type nodes AP₀, AP₁, AP₂, AP₃ is a backhaul communication via at least one corresponding backhaul channel H₁, Hz, H₃, H₄, and where the backhaul communication and the access communication both are performed by means of common equipment at each one of the first type nodes AP₀, AP₁, AP₂, AP₃.

According to some aspects, the method comprises performing S21 the prediction.

According to some aspects, the method comprises acquiring S22 the prediction from at least one of said other first type nodes AP₂, AP₃.

According to some aspects, the prediction is based on previously requested information.

According to some aspects, the previously requested information mostly comprises video information.

According to some aspects, the method comprises determining S4 if requested information already has been transmitted to one of said other first type nodes AP₂ for buffer storage and/or relaying, the requested information then having been comprised in the predicted information x₂₃.

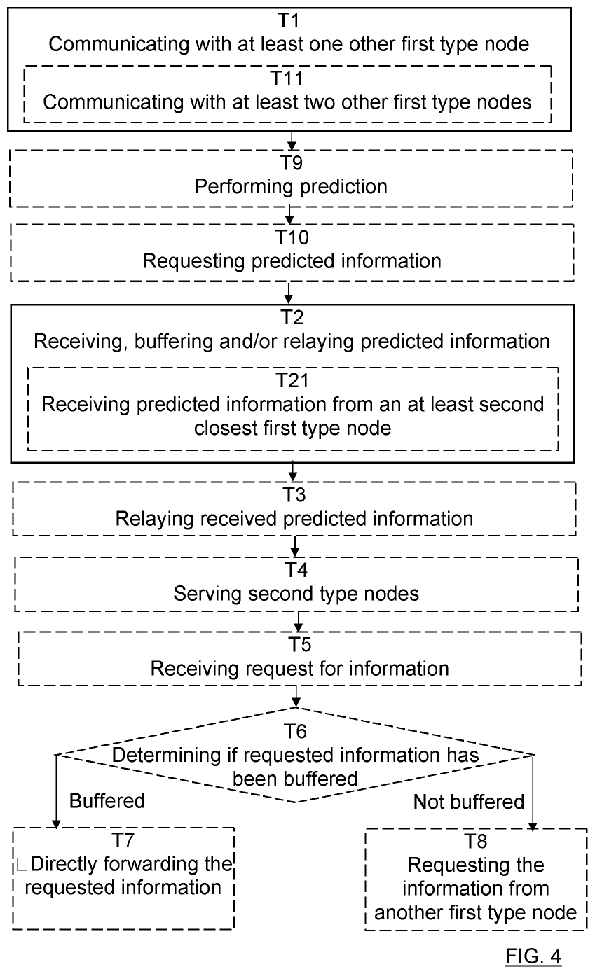

With reference to FIG. 4, the present disclosure also relates to method in a first type node first type node AP₂; AP₃ in a wireless communication system 1, wherein the method comprises communicating T1 with at least one other first type node AP₀, AP₁, AP₃; AP₂ in the wireless communication system 1 over a corresponding backhaul channel H₂, H₃, H₄, and receiving T2, buffering and/or relaying predicted information x₂₃ from at least one of said other first type nodes AP₀; AP₂, where the predicted information has been predicted to be requested via at least one of the second type nodes U₂₁, U₂₂; U₃₁, U₃₂ that is served by a first type node AP₂; AP₃.

According to some aspects, this applies to a case where aspects of the present disclosure can be more or less implemented at a first type node, for example the third access point AP₂ or the fourth access point AP₃ in the examples above. Such a first type node is not a donor node, such as the first access point AP₀.

According to some aspects, the method comprises communicating T11 with at least two other first type nodes AP₀, AP₁, and receiving T21 the predicted information x₂₃ from a second closest, or more remote, first type node AP₀, via a direct backhaul channel H₄, for buffer storage and/or relaying.

According to some aspects, the method comprises relaying T3 received predicted information x₂₃ to be stored and buffered at another first type node AP₃, where said second type node U₃₁, U₃₂ is served by said another first type node AP₃.

According to some aspects, the method comprises serving T4 a corresponding group of second type nodes U₂₁, U₂₂; U₃₁, U₃₂ via a corresponding access channel h₂₁, h₂₂; h₃₁, h₃₂, each group of second type nodes U₂₁, U₂₂; U₃₁, U₃₂ comprising at least one second type node U₂₁, U₂₂; U₃₁, U₃₂). The method further comprises receiving T5 request for information from at least one of the second type nodes U₂₁, U₂₂; U₃₁, U₃₂; and determining T6 if the requested information already has been buffered. If that is the case, the method comprises directly forwarding T7 the requested information to said second type nodes U₂₁, U₂₂; U₃₁, U₃₂ from the present buffer storage, otherwise requesting T8 the information from one other first type node AP₀; AP₂.

According to some aspects, the method comprises performing T9 the prediction, and requesting T10 the predicted information from another first type node AP₀; AP₂.

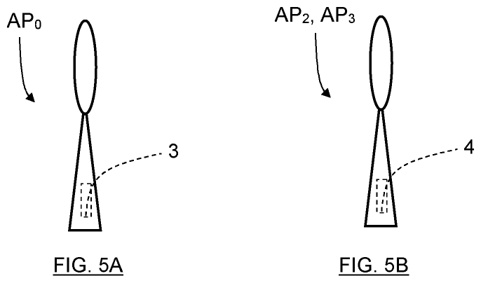

As shown in FIG. 5A, according to some aspects, a first type node AP₀ in a wireless communication system 1 comprises a processor unit 3 that is adapted to control communication with at least one other first type node AP₁, AP₂ in the wireless communication system 1 over a corresponding backhaul channel H₁, H₄. The processor unit 3 is further adapted to acquire a prediction for information x₂₃ to be requested via at least one of said other first type nodes AP₂, AP₃, and to control transmission of the predicted information x₂₃ to one of said other first type nodes AP₂ for buffer storage and/or relaying.

According to some aspects, the first type node is the first access point AP₀ in the examples above.

According to some aspects, the first type node AP₀ is adapted to communicate with at least two other first type nodes AP₁, AP₂, and the first type node AP₀ is adapted to transmit the predicted information x₂₃ to a second closest, or more remote, first type node AP₂, via a direct backhaul channel H₄, for buffer storage and/or relaying.

According to some aspects, the processor unit 3 is adapted to perform the prediction or to acquire the prediction from at least one of said other first type nodes AP₂, AP₃.

According to some aspects, the processor unit 3 is adapted to determine if requested information already has been transmitted to one of said other first type nodes AP₂ for buffer storage and/or relaying, the requested information then having been comprised in the predicted information x₂₃.

As shown in FIG. 5B, according to some aspects, a first type node AP₂; AP₃ in a wireless communication system 1 comprises a processor unit 4 that is adapted to control communication with at least one other first type node AP₀, AP₁, AP₃; AP₂ in the wireless communication system 1 over a corresponding backhaul channel H₂, H₃, H₄, and to control reception, buffering and/or relaying of predicted information x₂₃ from at least one of said other first type nodes AP₀; AP₂, where the predicted information has been predicted to be requested via at least one of the second type nodes U₂₁, U₂₂; U₃₁, U₃₂ that is served by a first type node AP₂; AP₃.

According to some aspects, the first type node is the third access point AP₂ in the examples above. Such a first type node is not a donor node, such as the first access point AP₀.

According to some aspects, the processor unit 4 is adapted to control communication with at least two other first type nodes AP₀, AP₁, and to control reception of predicted information x₂₃ from a second closest, or more remote, first type node AP₀, via a direct backhaul channel H₄, for buffer storage and/or relaying.

According to some aspects, the processor unit 4 is adapted to control relaying of the received predicted information x₂₃ to be stored and buffered at another first type node AP₃, where said second type node U₃₁, U₃₂ is served by said another first type node AP₃.

According to some aspects, the first type node AP₂; AP₃ is adapted to serve a corresponding group of second type nodes U₂₁, U₂₂; U₃₁, U₃₂ via a corresponding access channel h₂₁, h₂₂; h₃₁, h₃₂, each group of second type nodes U₂₁, U₂₂; U₃₁, U₃₂ comprising at least one second type node U₂₁, U₂₂; U₃₁, U₃₂. According to some further aspects, the processor unit 4 is adapted to control reception of request for information from at least one of the second type nodes U₂₁, U₂₂; U₃₁, U₃₂, and to determine if the requested information already has been buffered and if that is the case, directly forward the requested information to said second type nodes U₂₁, U₂₂; U₃₁, U₃₂ from the present buffer storage, otherwise request the information from one other first type node AP₀; AP₂.

According to some aspects, the processor unit 4 is adapted to perform the prediction, and to request the predicted information from another first type node AP₀; AP₂.

The present disclosure is not limited to the above, but may vary freely within the scope of the appended claims. For example, in the examples discussed above, the first access point AP₀ connects to the third access point AP₂ directly to provide it with the signals of the served CPE:s U₂₁, U₂₂; U₃₁, U₃₂ of both the third access point AP₂ and the fourth access point AP₃. However, according to some aspects, the first access point AP₀ is adapted to directly transmit predicted information to any access point that is not closest to the first access point AP₀, for example directly to the fourth access point AP₃ in a fifth time period E for direct backhauling of the fourth access point AP₃.

In the examples discussed above, a time slot 6 is divided into sub-slots TX₁, RX₁, each one having access and backhaul connections. In another approach, a time slot is divided into access and backhaul sub-slots where each one has DL and UL transmission. Generally, the present disclosure is applicable for different schemes of time allocation.

The efficiency of the present disclosure depends on if an efficient algorithm can be used to predict the required signals of the CPE:s as well as the efficiency of the search algorithm. However, because an IAB network mostly is designed for FWA networks with stationary CPE:s, such algorithms can be effectively developed and applied for the cases with, e.g., video streams and social media. According to some aspects, the prediction is based on previously requested information, and according to some further aspects, the previously requested information mostly comprises video information.

According to some aspects, the efficiency of the present disclosure depends on the amount of interference added to the access links between the second access point AP₁ and its served CPE:s U₁₁, U₁₂ by means of the direct transmission from, for example, the first access point AP₀ to the third access point AP₂. However, because the AP:s normally are equipped with many antennas and advanced beamforming methods, and also because the direct communication via the direct channel H₄ does not need to have high rate and, consequently, possibly relatively low transmission power, the interference to the access links between the second access point AP₁ and its served CPE:s U₁₁, U₁₂ will be negligible. This is especially because an IAB network normally is used for stationary networks where the channel measurements and parameter settings can be done before the data transmission.

According to some aspects, examples of important parts of the present disclosure are:
1) Utilizing idle time periods A of the time slots 6 for offline backhauling which improves the end-to-end transmission delay and throughput of the IAB network 7.
2) Developing prediction and search algorithms in the IAB donor node and/or other IAB nodes or access points.
3) Adapting the data transmission, the buffering as well as the encryption/decryption schemes of the access points.
4) Developing signaling methods between access points to convey information regarding whether a message comprising information already has been buffered by offline backhauling or not.
5) Adapting the scheduling and timing based on this signaling. The present disclosure address the main problems of IAB networks which are the large end-to-end transmission delay of the last hops.

A direct channel H₄ that bypasses one or more CPE:s can be set up where possible, possibly by the CPE:s involved adapting transmission parameters, e.g., data rate, power and beamforming, depending on the quality of the direct channel.

According to some aspects, the first access point AP₀ is adapted to communicate with at least two other access points AP₁, AP₂, and the first type node AP₀ is adapted to transmit the predicted information x₂₃ to a second closest, or more remote, first type node, such as the third access point AP₂ via a direct backhaul channel, for buffer storage and/or relaying. This means that at least one access point such as the second access point AP₁ is bypassed by means of one or more direct backhaul channels.

According to some aspects, the present disclosure can easily extended to the cases with arbitrary number of hops, different relaying approaches or star-like network configuration.

According to some aspects, in the present context, the term information corresponds to a data signal or a data message. According to some aspects, in the present context, the terms relay and relaying correspond to the terms forward and forwarding.

The present disclosure has been described for an uncomplicated case with relatively few hops, although the present disclosure can be applied to the cases with arbitrary number of hops and CPE:s. Any CPE or CPE:s can be adapted to encrypt/decrypt information received from the first access point AP₀ or any suitable IAB donor node, as well as information requests of the CPE:s. this means that aspects of the present disclosure can be more or less implemented at an IAB donor node such as the first access point AP₀ as well as at any other suitable AP or AP:s in the wireless communication system 1.

In the examples, the third access point AP₂ has been adapted to communicate directly with the first access point AP₀ via the direct backhaul channel H₄, but not the fourth access point AP₃ that has to depend on relaying via the third access point AP₂ for both uplink and downlink. According to some aspects, there can be several (not shown) intermediate access points between the third access point AP₂ and the fourth access point AP₃. According to some aspects, the fourth access point AP₃ and possibly one or more other (not shown) access points can also be adapted to communicate directly with the first access point AP₀ via corresponding direct backhaul channels.

According to some aspects, an access points that is adapted to communicate directly with the first access point AP₀ via a direct backhaul channel, such as the third access point AP₂, can both buffer predicted information intended for its own served CPE:s and relay other predicted information intended for CPE:s that are served by other AP:s for storage and buffering at those AP:s.

According to some aspects, the wireless communication system 1 comprises one or more IAB networks 7.

Generally, the present disclosure relates to a first type node AP₀ in a wireless communication system 1, wherein the first type node AP₀ is adapted to communicate with at least one other first type node AP₁, AP₂ in the wireless communication system 1 over a corresponding backhaul channel H₁, H₄. The first type node AP₀ is further adapted to acquire a prediction for information x₂₃ to be requested via at least one of said other first type nodes AP₂, AP₃, and to transmit the predicted information x₂₃ to one of said other first type nodes AP₂ for buffer storage and/or relaying.

According to some aspects, this applies to a case where aspects the present disclosure can be more or less implemented at an IAB donor node such as the first access point AP₀.

According to some aspects, the first type node AP₀ is adapted to communicate with at least two other first type nodes AP₁, AP₂, and the first type node AP₀ is adapted to transmit the predicted information x₂₃ to a second closest, or more remote, first type node AP₂, via a direct backhaul channel H₄, for buffer storage and/or relaying.

According to some aspects, at least one of the other first type nodes AP₁, AP₂, AP₃ is adapted to communicate with a corresponding group of second type nodes U₁₁, U₁₂, U₂₁, U₂₂, U₃₁, U₃₂ via a corresponding access channel h₁₁, h₁₂, h₂₁, h₂₂, h₃₁, h₃₂. Each group of second type nodes U₁₁, U₁₂, U₂₁, U₂₂, U₃₁, U₃₂ comprises at least one second type node U₁₁, U₁₂, U₂₁, U₂₂, U₃₁, U₃₂, where information x₂₃ to be requested via at least one of said other first type nodes AP₂, AP₃ corresponds to information to be requested by at least one of said second type nodes U₂₁, U₂₂, U₃₁, U₃₂.

This mean that one or more CPE:s makes requests for information, and the one or more requests for information are relayed via one or more AP:s. Information that is requested via an AP is requested by at least one CPE.

According to some aspects, the communication between the first type nodes AP₀, AP₁, AP₂, AP₃ is a backhaul communication via at least one corresponding backhaul channel H₁, H₂, H₃, H₄, and the backhaul communication and the access communication both are performed by means of common equipment at each one of the first type nodes AP₀, AP₁, AP₂, AP₃.

According to some aspects, the first type node AP₀ is adapted to perform the prediction. According to some aspects, the prediction can be performed at any other access point on the IAB network, at a remote node 8 or at a server 9 that can be realized in the cloud. Such a remote node 8 or server 9 should be enabled to perform encryption/decryption.

According to some aspects, the first type node AP₀ is adapted to acquire the prediction from at least one of said other first type nodes AP₂, AP₃. In this case, each first type node AP₂, AP₃ that is able to perform the prediction, has encryption/decryption ability.

According to some aspects, the transmitted predicted information x₂₃ is relayed from one other first type node AP₂ to another first type node AP₃. In this case, the transmitted predicted information x₂₃ can have been buffered at the other first type node AP₂ before being relayed to said another first type node AP₃, where the transmitted predicted information x₂₃ also can be buffered.

According to some aspects, the first type node AP₀ is adapted to determine if requested information already has been transmitted to one of said other first type nodes AP₂ for buffer storage and/or relaying, the requested information then having been comprised in the predicted information x₂₃.

According to some aspects, the first type node AP₀ is connected to a core network 2 using a fiber connection 5.

Generally, the present disclosure also relates to a first type node AP₂; AP₃ in a wireless communication system 1, wherein the first type node AP₂; AP₃ is adapted to:
communicate with at least one other first type node AP₀, AP₁, AP₃; AP₂ in the wireless communication system 1 over a corresponding backhaul channel H₂, H₃, H₄, and to
receive and buffer and/or relay predicted information x₂₃ from at least one of said other first type nodes AP₀; AP₂, where the predicted information has been predicted to be requested via at least one second type node U₂₁, U₂₂; U₃₁, U₃₂ that is served by a first type node AP₂; AP₃.

According to some aspects, this applies to a case where aspects of the present disclosure can be more or less implemented at a first type node, for example the third access point AP₂ or the fourth access point AP₃ in the examples above. Such a first type node is not a donor node, such as the first access point AP₀.

According to some aspects, the first type node AP₂ is adapted to:
communicate with at least two other first type nodes AP₀, AP₁, and
to receive predicted information x₂₃ from a second closest, or more remote, first type node AP₀, via a direct backhaul channel H₄, for buffer storage and/or relaying.

According to some aspects, the first type node AP₂ is adapted to relay the received predicted information x₂₃ to be stored and buffered at another first type node AP₃, where said second type node U₃₁, U₃₂ is served by said another first type node AP₃.

According to some aspects, the first type node AP₂; AP₃ is adapted to:
serve a corresponding group of second type nodes U₂₁, U₂₂; U₃₁, U₃₂ via a corresponding access channel h₂₁, h₂₂; h₃₁, h₃₂, each group of second type nodes U₂₁, U₂₂; U₃₁, U₃₂ comprising at least one second type node U₂₁, U₂₂; U₃₁, U₃₂,
receive request for information from at least one of the second type nodes U₂₁, U₂₂; U₃₁, U₃₂, and to
determine if the requested information already has been buffered and if that is the case, directly forward the requested information to said second type nodes U₂₁, U₂₂; U₃₁, U₃₂ from the present buffer storage, otherwise request the information from one other first type node AP₀; AP₂.

According to some aspects, the first type node AP₂; AP₃ is adapted to perform the prediction, and to request the predicted information from another first type node AP₀; AP₂.

The present disclosure also relates to a wireless communication system 1 comprising an integrated access and backhaul, IAB, network 7 which in turn comprises at least the first type node AP₀ that is a donor node and a first type node AP₂, AP₃ that is a not donor node.

1. A first type node in a wireless communication system, the first type node comprising:
memory; and
processing circuitry coupled to the memory, wherein the first type node is configured to:
communicate with at least one other first type node in the wireless communication system over a corresponding backhaul channel;
acquire a prediction for information to be requested via at least one of said other first type nodes; and
transmit the predicted information to one of said other first type nodes for buffer storage and/or relaying.

2. The first type node of claim 1, wherein the first type node is adapted to communicate with at least two other first type nodes, and the first type node is adapted to transmit the predicted information to a second closest, or more remote, first type node, via a direct backhaul channel, for buffer storage and/or relaying.

3. The first type node of claim 1, wherein at least one of the other first type nodes is adapted to communicate with a corresponding group of second type nodes via a corresponding access channel, each group of second type nodes comprising at least one second type node, where information to be requested via at least one of said other first type nodes corresponds to information to be requested by at least one of said second type nodes.

4. The first type node of claim 1, wherein the communication between the first type nodes is a backhaul communication via at least one corresponding backhaul channel, and where the backhaul communication and the access communication both are performed by means of common equipment at each one of the first type nodes.

5. The first type node of claim 1, wherein the first type node is adapted to perform the prediction or acquire the prediction from at least one of said other first type nodes.

6. (canceled)

7. The first type node of claim 1, wherein the prediction is based on previously requested information.

8-9. (canceled)

10. The first type node of claim 1, wherein the first type node is adapted to determine if requested information already has been transmitted to one of said other first type nodes for buffer storage and/or relaying, the requested information then having been comprised in the predicted information.

11. The first type node of claim 1, wherein the first type node is connected to a core network by means of a fiber connection.

12. A first type node in a wireless communication system, the first type node comprising:
memory; and
processing circuitry coupled to the memory, wherein the first type node is configured to:
communicate with at least one other first type node in the wireless communication system over a corresponding backhaul channel; and
receive and buffer and/or relay predicted information from at least one of said other first type nodes, where the predicted information has been predicted to be requested via at least one second type node that is served by a first type node.

13. The first type node of claim 12, wherein the first type node is adapted to:
communicate with at least two other first type nodes; and
to receive predicted information from a second closest, or more remote, first type node, via a direct backhaul channel, for buffer storage and/or relaying.

14. (canceled)

15. The first type node of claim 12, wherein the first type node is adapted to:
serve a corresponding group of second type nodes via a corresponding access channel, each group of second type nodes comprising at least one second type node;
receive request for information from at least one of the second type nodes; and
determine if the requested information already has been buffered and if that is the case, directly forward the requested information to said second type nodes from the present buffer storage, otherwise request the information from one other first type node.

16. (canceled)

17. A method in a first type node first type node in a wireless communication system, wherein the method comprises:
communicating with at least one other first type node in the wireless communication system over a corresponding backhaul channel;
acquiring a prediction for information to be requested via at least one of said other first type nodes; and
transmitting the predicted information to one of said other first type nodes for buffer storage and/or relaying.

18. The method according to of claim 17, wherein the method comprises:
communicating with at least two other first type nodes; and
transmitting the predicted information to a second closest, or more remote, first type node, via a direct backhaul channel, for buffer storage and/or relaying.

19. The method of claim 17, wherein at least one of the other first type nodes is used for communicating with a corresponding group of second type nodes via a corresponding access channel, each group of second type nodes comprising at least one second type node, where information to be requested via at least one of said other first type nodes corresponds to information to be requested by at least one of said second type nodes.

20. The method of claim 17, wherein the communication between the first type nodes is a backhaul communication via at least one corresponding backhaul channel, and where the backhaul communication and the access communication both are performed by means of common equipment at each one of the first type nodes.

21. The method of claim 17, wherein the method comprises performing the prediction.

22-25. (canceled)

26. A method in a first type node first type node in a wireless communication system, wherein the method comprises:
communicating with at least one other first type node in the wireless communication system over a corresponding backhaul channel; and
receiving, buffering and/or relaying predicted information from at least one of said other first type nodes, where the predicted information has been predicted to be requested via at least one of the second type nodes that is served by a first type node.

27. The method of claim 26, wherein the method comprises:
communicating with at least two other first type nodes; and
receiving the predicted information from a second closest, or more remote, first type node, via a direct backhaul channel, for buffer storage and/or relaying.

28. (canceled)

29. The method of claim 26, wherein the method comprises:
serving a corresponding group of second type nodes via a corresponding access channel, each group of second type nodes comprising at least one second type node;
receiving request for information from at least one of the second type nodes; and
determining if the requested information already has been buffered and if that is the case,
directly forwarding the requested information to said second type nodes from the present buffer storage, otherwise
requesting the information from one other first type node.

30. (canceled)

31. A wireless communication system comprising an integrated access and backhaul network comprising at least the first type node of claim 1.
